(19) United States
(12) Patent Application Publication
(10) Pub. No.: US 2013/0145315 A1
(43) Pub. Date: Jun. 6, 2013

(54) ELECTRONIC DEVICE WITH MULTI-WINDOW DISPLAYING FUNCTION AND MULTI-WINDOW DISPLAYING METHOD THEREOF

(71) Applicants: HAI-BO ZHOU, Shenzhen (CN); CHIH-SAN CHIANG, New Taipei (TW); MIN YANG, Shenzhen (CN); HUA-DONG CHENG, Shenzhen (CN)

(72) Inventors: HAI-BO ZHOU, Shenzhen (CN); CHIH-SAN CHIANG, New Taipei (TW); MIN YANG, Shenzhen (CN); HUA-DONG CHENG, Shenzhen (CN)

(21) Appl. No.: 13/686,930

(22) Filed: Nov. 28, 2012

(30) Foreign Application Priority Data
Dec. 5, 2011 (CN) 201110398402.8

(51) Int. Cl. G06F 3/0481

(52) U.S. Cl. CPC G06F 3/0481
USPC 715/804

(57) ABSTRACT

An electronic device with multi-window displaying function includes an input unit, a storage unit, a display unit, and a processing unit. The processing unit includes an input responding module, a multi-window controlling module, and a display driving module. In a multi-window reading mode, the input responding module responds to a multi-window displaying command from the input unit; the multi-window controlling module controls the display unit to display multi sub-windows in a size corresponding to the number of windows to be displayed in each multi-window mode, and drives the display unit to display a first file on a first sub-window, the display driving module drives the display unit to display another file on other sub-windows according to user input.

### BACKGROUND

1. Technical Field

The present disclosure relates to electronic devices and screen display methods and particularly to an electronic device having multi-window displaying function and a multi-window displaying method applied on the electronic device.

2. Description of Related Art

When users reads a file on a display of an electronic device, if users want to read another file, users have to close or minimize the current displaying window and open a new file for displaying the new content. If users would like to display two files in two different windows on one screen, users have to actively reduce the sizes of the two windows for displaying two windows on one screen.

Therefore, what is needed is an electronic device with multi-window displaying function and a multi-window displaying method thereof alleviating the limitations described above.

### BRIEF DESCRIPTION OF THE DRAWINGS

The components in the drawings are not necessarily drawn to scale, the emphasis instead being placed upon clearly illustrating the principles of an electronic device having multi-window displaying function and a multi-window displaying method applied on the electronic device Moreover, in the drawings, like reference numerals designate corresponding parts throughout the several views.

FIG. 1 is a block diagram illustrating an electronic device with multi-window displaying function, according to an exemplary embodiment.

FIG. 2 is a schematic view of the electronic device with multi-window displaying function of FIG. 1, showing a normal reading mode.

FIG. 3 is a schematic view of the electronic device with multi-window displaying function of FIG. 1, showing a multi-window reading mode.

FIG. 4 is a flowchart of a multi-window displaying method of the electronic device with multi-window displaying function of FIG. 1, in accordance with the exemplary embodiment.

FIG. 5 is a sub-flowchart of step S406 of the multi-window displaying method of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

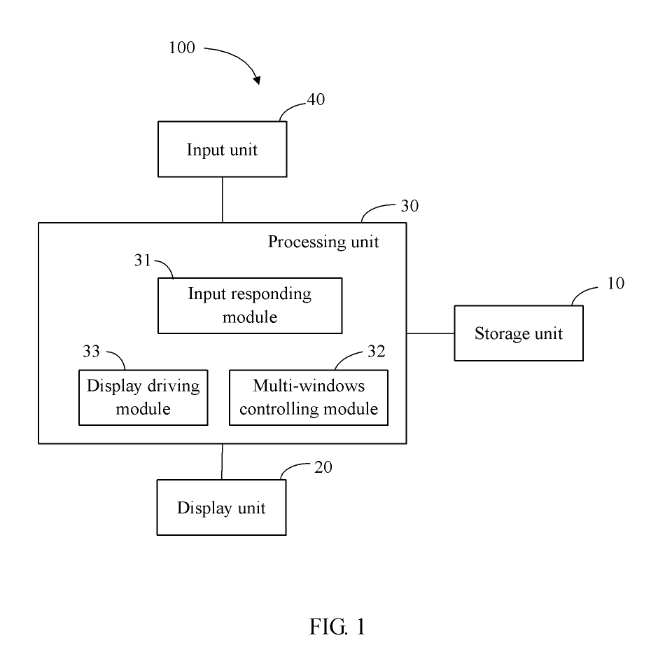

Referring to FIG. 1, an electronic device 100 with multi-window displaying function is disclosed as an exemplary embodiment. The electronic device 100 includes a storage unit 10, a display unit 20, a processing unit 30, and an input unit 40. The storage unit 10 stores electronic files to be displayed on a screen of the display unit 20 for users to read, the electronic files can be PDF files, WORD files, TXT files or image or other files. The input unit 40 may be one or more buttons, a mouse or a touch panel. In this embodiment, the input unit 40 receives user inputs and generates signals, the input operations by the user include character input, start a reading application software, open or close a file, start or close a multi-window reading mode, and the like.

In this embodiment, the processing unit 30 includes an input responding module 31, a multi-window controlling module 32, and a display driving module 33. The input responding module 31 responds to the signals generated by the input unit 40, and the display driving module 33 drives the display unit 20 for displaying content.

Users can input a command of start a multi-window reading mode via the input unit 40. For example, users can apply any regular input methods to input a command, like pressing a button to input a command to start a multi-window reading mode, touching a virtual icon displayed on the touch screen to input a command to start a multi-window reading mode, or clicking a command in a menu via a mouse to input a command to start a multi-window reading mode etc.

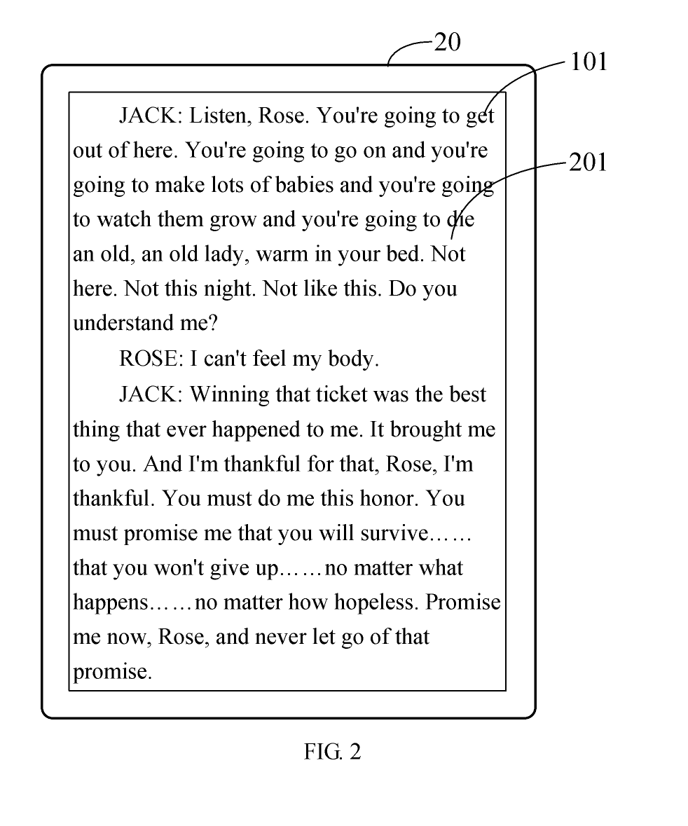

Referring to FIG. 2, in a normal reading mode, the input unit 40 receives user's input operation for opening a file and generates a file opening signal. The input responding module 31 responds to the file opening signal and sends a file displaying command to the display driving module 33. The display driving module 33 determines the file chosen by the user, reads the file from the storage unit 10 and drives the display unit 20 to display the content of the file in full screen according to the file displaying command. In this embodiment, if user chooses a first file 201 having multiple pages, the display driving module 33 drives the display unit 20 to display the first page 101 of the first file 201 on the display unit 20, in full screen.

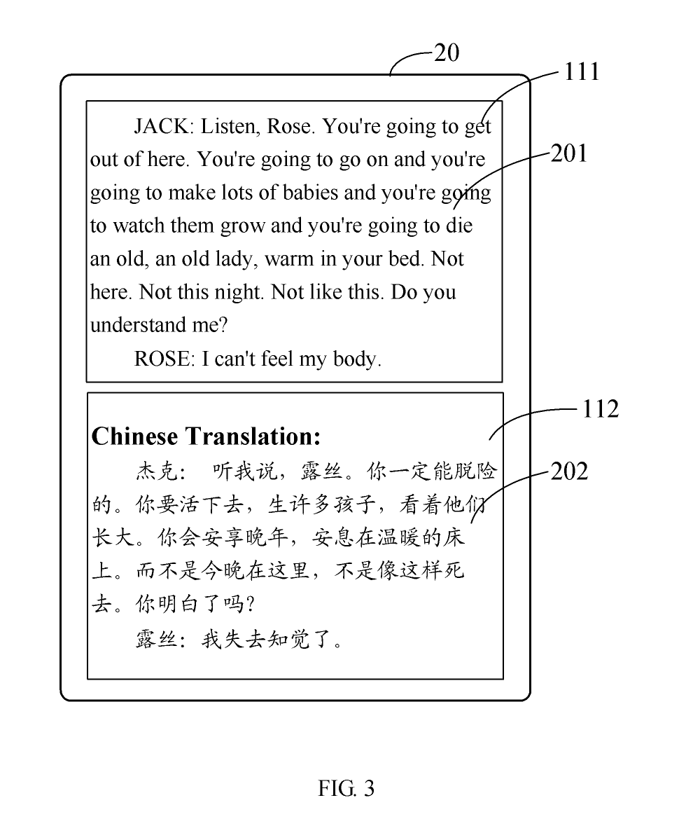

Referring to FIG. 3, in a multi-window reading mode, the input unit 40 receives user's input operation for starting the multi-window reading mode and generates a multi-window displaying signal. The input responding module 31 responds to the multi-window displaying signal and sends a multi-window displaying command to the multi-window controlling module 32 and the display driving module 33. The multi-window reading mode mentioned above includes a two-window reading mode displaying two sub-windows, each in half of full screen, a three-windows reading mode displaying three sub-windows, each in one third of full screen, and four or more windows reading mode. In the multi-window reading mode, the sub-windows are displayed on the screen either side by side (horizontally) or stacked vertically.

The multi-window controlling module 32 controls the display unit 20 to display multi sub-windows in a size which depends on the number of windows to be displayed in the preferred mode, and controls the display unit 20 to display the current first file on a first sub-window according to the multi-window displaying command The display driving module 33 responds to the multi-window displaying command and drives the display unit 20 to display a second file on another sub-window according to user's input. In an exemplary embodiment, the display driving module 33 drives the display unit 20 to display a prompt box to allow a user to choose files to be displayed on the other sub-windows. The input unit 40 receives user selection of a file and generates a file chosen signal. The input responding module 31 responds to the file chosen signal and sends a file chosen command to the display driving module 33. The display driving module 33 reads the chosen file from the storage unit 10 and drives the display unit 20 to display the content of the chosen second file on another sub-window according to the file chosen command The file chosen by the user to be displayed on the other sub-window(s) is a file which is independent from the current first file.

Taking the two-window reading mode for example, users input a command for starting the two-window reading mode, the input unit 40 receives the user input and generates a two-window displaying signal. The input responding module 31 responds to the two-window displaying signal and sends a two-window displaying command to the multi-window controlling module 32 and the display driving module 33.

The multi-window controlling module 32 controls the display unit 20 to split the window in two, each half-size window occupies a half of the screen, and controls the display unit 20 to display the current first file 201 on a first sub-window 111 according to the multi-window displaying command. The display driving module 33 responds to the multi-window displaying command and drives the display unit 20 to display a chosen second file on another sub-window 112 according to user's input. In this embodiment, the display driving module 33 drives the display unit 20 to display a prompt box to allow a user to choose a file 202 to be displayed on the another sub-window 112 according to the multi-window displaying command The input unit 40 receives user input and generates a file chosen signal. The input responding module 31 responds to the file chosen signal and sends a file chosen command to the display driving module 33. The display driving module 33 reads the chosen file 202 from the storage unit 10 and drives the display unit 20 to display the content of the chosen second file on the other sub-window 112 according to the file chosen command

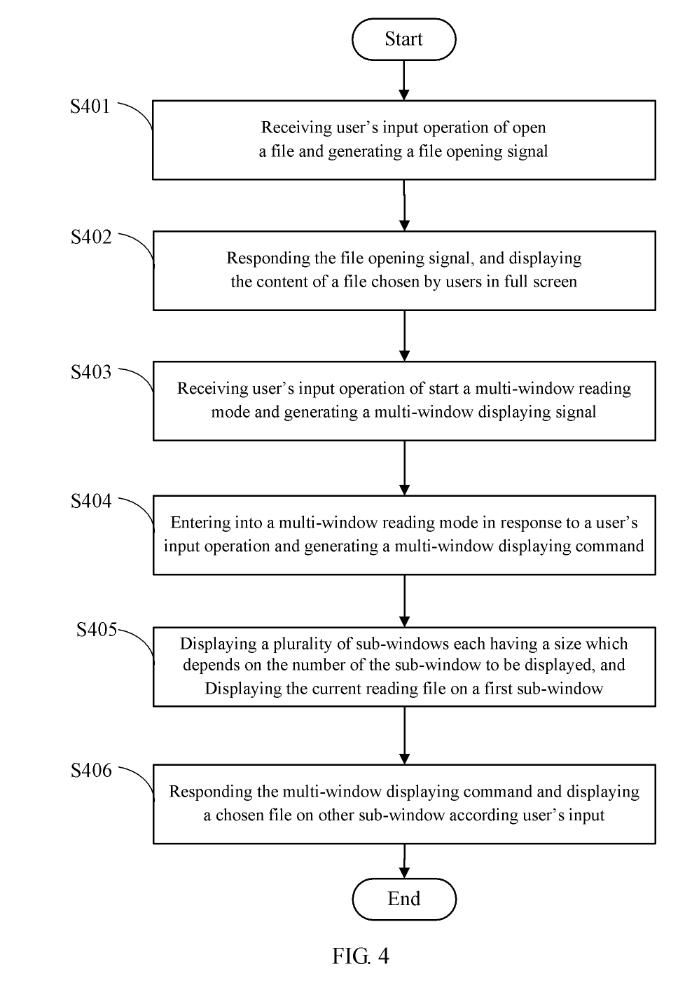

Referring to FIGS. 1 and 4, FIG. 1 shows a flowchart of a multi-window displaying method of the electronic device 100. The method includes the following steps, each of which is tied to various components contained in the electronic device 100 as shown in FIG. 1.

In step S401, the input unit 40 receives user's input for opening a file and generates a file opening signal.

In step S402, the input responding module 32 responds to the file opening signal, and the display driving module 33 drives the display unit 20 to display the content of a file chosen by users, in full screen.

In step S403, the input unit 40 receives user input for starting a multi-window reading mode and generates a multi-window displaying signal.

In step S404, the input responding module 31 enters into a multi-window reading mode in response to a user's input operation in response to the multi-window displaying signal and sends a multi-window displaying command to the multi-window controlling module 32 and the display driving module 33.

In step S405, the multi-window controlling module 32 controls the display unit 20 to display a plurality of sub-windows each having a size which depends on the number of the sub-windows to be displayed, and controls the display unit 20 to display the current (first) file on a first sub-window according to the multi-window displaying command

In step S406, the display driving module 33 responds to the multi-window displaying command and drives the display unit 20 to display a chosen (second) file on another sub-window according to user's input operation.

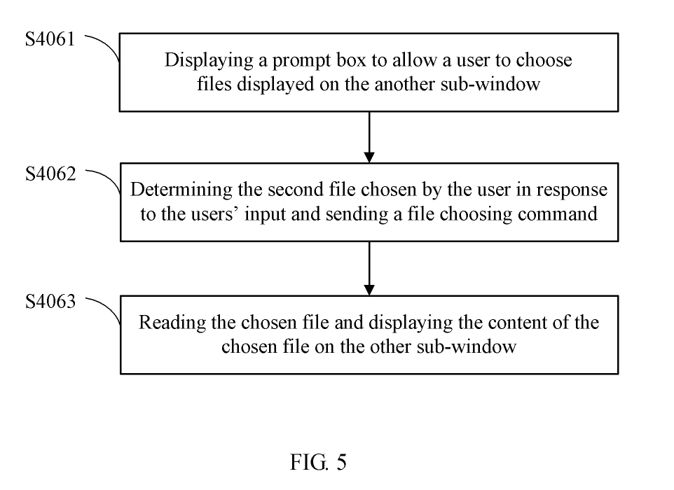

Referring to FIGS. 5, step S406 of the multi-window displaying method of FIG. 4 includes the following sub-steps:

In step S4061, the display driving module 33 drives the display unit 20 to display a prompt box to allow a user to choose a second file to be displayed on another sub-window according to the multi-window displaying command.

In step S4062, the input responding module 31 determining the second file chosen by the user in response to the users' input operation and sends a file chosen command to the display driving module 33.

In step S4063, the display driving module 33 reads the second file from the storage unit 10 and drives the display unit 20 to display the content of the second file on the other sub-window 112 according to the file chosen command

With such configuration, the electronic device 100 can display two files in two different windows on one screen simultaneously, and users do not need to adjust the page width or other parameters of the two windows for displaying two windows on one screen simultaneously. The electronic device 100 responds to user commands to start the multi-window reading mode and user choice of another file to be displayed together with the current file in two different windows on one screen automatically.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
an input unit configured for receiving input operations by a user and generating input signals associated therewith, the input signals including file opening signals and multi-window displaying signals;
a storage unit configured for storing electronic files;
a display unit configured for displaying content of the electronic files stored in the storage unit;
a processing unit comprising an input responding module, a multi-window controlling module, and a display driving module;
wherein in a normal reading mode, the input responding module is configured for responding to a file opening signal generated by the input unit in a normal reading mode;
the display driving module is configured for driving the display unit to display the content of a first file chosen by a user in full screen;
in a multi-window reading mode, the input responding module is configured for responding to a multi-window displaying signal generated by the input unit; the multi-window controlling module is configured for controlling the display unit to display multi sub-windows in a size which depends on the number of windows to be displayed, and controlling the display unit to display the first file on a first sub-window, the display driving module is configured for driving the display unit to display another file chosen by users on another sub-window according to user's input.

2. The electronic device as described in claim 1, wherein the input unit is a button, a mouse or a touch panel.

3. The electronic device as described in claim 1, wherein the sub-windows are displayed on the display unit side by side along a horizontal direction or a vertical direction of the electronic device.

4. The electronic device as described in claim 1, wherein in the normal reading mode, the input responding module is further configured for sending a file displaying command to the display driving module; the display driving module determines a file chosen by the user, reads the file from the storage unit and drives the display unit to display the content of the file in full screen according to the file displaying command.

5. The electronic device as described in claim 1, wherein in the multi-window reading mode, the input responding is further configured for sending a multi-window displaying command to the multi-window controlling module and the display driving module.

6. The electronic device as described in claim 4, wherein the display driving module drives the display unit to display a prompt box to allow a user to choose files to be displayed on the other sub-windows according to the multi-window displaying command;
the input unit receives user's file choosing operation and generates a file choosing signal associated therewith; the input responding module responds to the file choosing signal and sends a file choosing command to the display driving module, the display driving module determines the file chosen by the user, reads the chosen file from the storage unit and drives the display unit displaying the content of the file on another sub-window according to the file choosing command.

7. An multi-window displaying method of an electronic device, comprising:
S1, entering into a multi-window reading mode in response to a user's input operation;
S2, generating a multi-window displaying command;
S3, displaying a plurality of sub-windows each having a size which depends on the number of the sub-windows to be displayed, and displaying a first file on a first sub-window according to the multi-window displaying command; and
S4, displaying a second file on another sub-window according to user's input operation.

8. The method as described in claim 7, wherein the step S4 further comprises the following sub-steps:
S41, displaying a prompt box to allow a user to choose the second file to be displayed on the another sub-window;
S42, determining the second file chosen by the user in response to the users' input operation;
S43, displaying the content of the second file on the another sub-window.

9. The method as described in claim 7, wherein the sub-windows are displayed on the display unit side by side in a horizontal direction or a vertical direction of an electronic device.
